(19) United States
(12) Patent Application Publication
(10) Pub. No.: US 2015/0378014 A1
(43) Pub. Date: Dec. 31, 2015

(54) ASCERTAINING CLASS OF A VEHICLE CAPTURED IN AN IMAGE

(71) Applicant: Sandia Corporation, Albuquerque, NM (US)

(72) Inventors: Melissa Linae Koudelka, Albuquerque, NM (US); Brian K. Bray, Albuquerque, NM (US); John Richards, Albuquerque, NM (US)

(21) Appl. No.: 14/334,147

(22) Filed: Jul. 17, 2014

Related U.S. Application Data
(60) Provisional application No. 61/863,205, filed on Aug. 7, 2013.

(51) Int. Cl. G01S 13/04; G01S 13/90; G01S 13/89

(52) U.S. Cl. CPC G01S 13/04; G01S 13/89; G01S 13/90

(57) ABSTRACT

Described herein are various technologies pertaining to detecting a vehicle in an image and determining a class of vehicle to which the vehicle belongs. In a general embodiment, the image is output by a radar-based imaging system, such as a synthetic aperture radar (SAR) imaging system. The image is processed to generate a signature for the vehicle, the signature being a one-dimensional array. The class of the vehicle is determined based upon a comparison of the signature for the vehicle with a template signature for the class.

### RELATED APPLICATION

This application claims priority to U.S. Provisional Patent Application No. 61/863,205, filed on Aug. 7, 2013, and entitled “SYNTHETIC APERTURE RADAR LONGITUDINAL PROFILER”, the entirety of which is incorporated herein by reference.

### STATEMENT OF GOVERNMENTAL INTEREST

This invention was developed under Contract DE-AC04-94AL85000 between Sandia Corporation and the U.S. Department of Energy. The U.S. Government has certain rights in this invention.

### BACKGROUND

In surveillance applications, it may be desirable to analyze images captured by an airborne imaging system to identify particular objects in such images. For example, an imaging system can be placed on an airplane flying several thousand feet above the surface of the earth, and can capture images that are desirably analyzed. For instance, it may be desirable to analyze the image to recognize buildings therein, to identify a particular type of building, to identify a roadway, etc.

Currently, computer-implemented systems have been developed for identifying vehicles that are captured in images generated by an airborne imaging system. Such computer-implemented systems, however, are not particularly robust, and require frequent updates. For instance, a conventional image analysis tool can identify a particular make and model of a vehicle captured in an image (e.g., a particular type of tank, a particular type/brand of automobile, etc.). If, however, a manufacturer of the vehicle (or owner of the vehicle) makes a relatively small modification to the vehicle, the conventional tool may not accurately recognize such vehicle (due to the relatively small modification). Accordingly, such image analysis tool must be updated for each alteration made to a vehicle by the manufacturer (e.g., each model year), and is further not robust with respect to relatively small modifications made to vehicles by owners. For example, if the image analysis system tool is configured to identify a particular make and model of a truck, such image analysis system may fail if the owner of the truck extends the truck bed by a relatively small amount.

### SUMMARY

The following is a brief summary of subject matter that is described in greater detail herein. This summary is not intended to be limiting as to the scope of the claims.

Described herein are various technologies pertaining to a vehicle class identification system. With more particularity, in a general embodiment, an image analysis system is described herein that can analyze images captured by a radar-based imaging system, such as a synthetic aperture radar (SAR) imaging system, wherein analyzing an image can includes identifying existence of a vehicle in an image generated by the radar-based imaging system, and further includes identifying a class of the vehicle. Further, such analysis can be undertaken in real-time, as images are generated by the radar-based imaging system. Exemplary vehicle classes may include, for example, a truck class, a passenger sedan class, a sport-utility vehicle class, a van class, a heavy armor class, an air defense class, or a personnel transport, etc.

In an exemplary embodiment, a SAR imaging system is particularly well-suited for surveillance applications, as images of the surface of the earth can be generated regardless of weather conditions, time of day, etc. In an example, an image generated by the SAR imaging system can be normalized based upon range resolution or azimuthal resolution corresponding to the image, wherein are respectively based upon signal bandwidth and center frequency and aperture transversed to form the image. Thus, a normalized image is generated. Moreover, the image can be scaled, rotated, etc., such that vehicles existent in the image can be identified regardless of vehicle orientation or viewing angle. Existence of a vehicle (without regard to class) can be identified in the normalized image. In another exemplary embodiment, existence of a vehicle can be identified in the original image output by the radar-based imaging system. Existence of the vehicle can be identified, for instance, by computing an intensity gradient image (from the normalized image or the original image) and identifying edges in the intensity gradient image. Other techniques for identifying the existence of vehicles in the image are also contemplated.

Responsive to identifying the portion of the image (normalized or original) that comprises the vehicle, a major axis of the vehicle can be identified (e.g., the axis running the length of a wheelbase of the vehicle). A one-dimensional signature can then be generated based upon, for example, the identified major axis of the vehicle. In an exemplary embodiment, intensity values of respective pixels along a width of the vehicle can be summed for each point along the major axis of the vehicle when generating the signature. The resultant one-dimensional signature can thus be a one-dimensional array comprising a plurality of elements having a respective plurality of values, wherein each value is indicative of a summation of intensity values of pixels along a minor axis at a point on the major axis corresponding to the respective element of the one-dimensional array. To account for noise, some processing may be undertaken on the pixel values; for instance, intensity values deviating by a threshold amount from a median intensity value can be filtered or removed.

The resultant one-dimensional signature may then be compared with at least one template signature for a vehicle class. The at least one template signature can be generated during a training phase, for example, and is generally representative of a particular vehicle class. A similarity score can be computed based upon the comparison, and a determination can be made as to whether the vehicle in the image belongs to the class based upon the similarity score. Such a process can be repeated for each vehicle identified in an image captured by the radar-based imaging system, for a plurality of template signatures corresponding to respective vehicle classes.

The above summary presents a simplified summary in order to provide a basic understanding of some aspects of the systems and/or methods discussed herein. This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented later.

### BRIEF DESCRIPTION OF THE DRAWINGS

FIG. 1 is a functional block diagram of an exemplary system that facilitates determining a class of a vehicle identified in an image output by a radar-based imaging system.

FIG. 2 illustrates exemplary operation of a cuer and indexer component.

FIG. 3 illustrates exemplary operation of a normalizer component.

FIG. 4 illustrates exemplary operation of a signature generator component.

FIG. 5 is a functional block diagram of an exemplary system that facilitates learning a template signature for a particular vehicle class.

FIG. 6 is a flow diagram illustrating an exemplary methodology that facilitates assigning a label to an image based upon a determination that a vehicle in the image belongs to a particular vehicle class.

FIG. 7 is a flow diagram that illustrates an exemplary methodology for constructing a one-dimensional signature for a portion of an image that potentially includes a vehicle.

FIG. 8 is a flow diagram illustrating an exemplary methodology for learning a template signature for a particular vehicle class.

FIG. 9 is an exemplary computing system.

### DETAILED DESCRIPTION

Various technologies pertaining to determining a class of a vehicle captured in an image generated by a radar-based imaging system are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects. Further, it is to be understood that functionality that is described as being carried out by a single system component may be performed by multiple components. Similarly, for instance, a single component may be configured to perform functionality that is described as being carried out by multiple components.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

Further, as used herein, the terms “component” and “system” are intended to encompass computer-readable data storage that is configured with computer-executable instructions that cause certain functionality to be performed when executed by a processor. The computer-executable instructions may include a routine, a function, or the like. It is also to be understood that a component or system may be localized on a single device or distributed across several devices. Additionally, as used herein, the term “exemplary” is intended to mean serving as an illustration or example of something, and is not intended to indicate a preference.

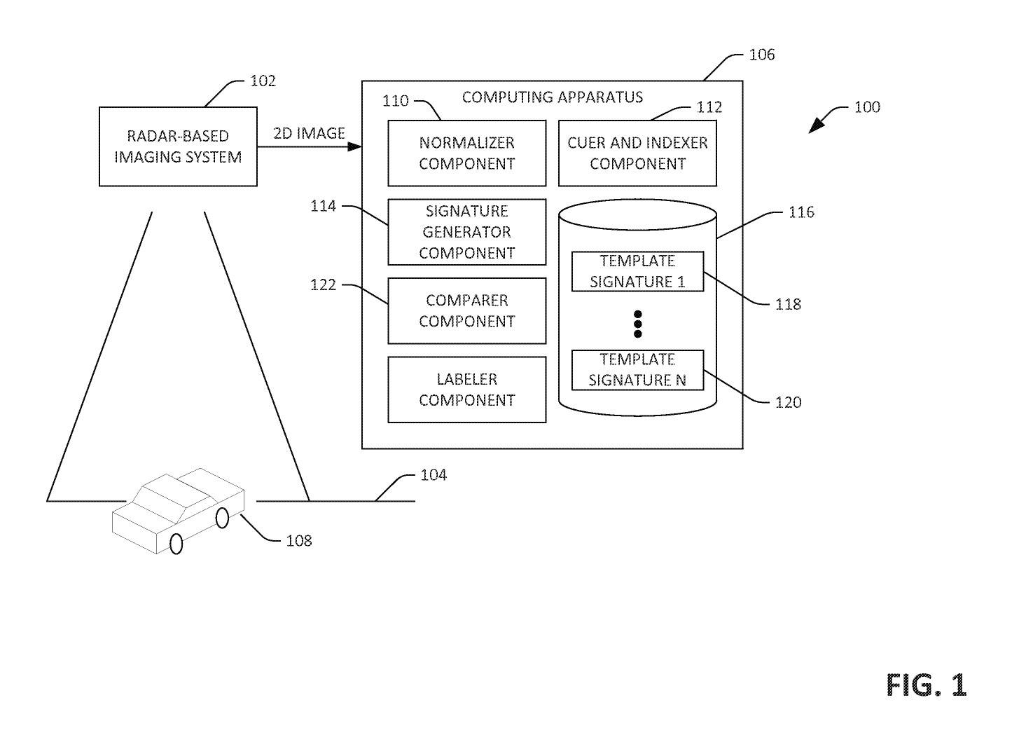

With reference now to FIG. 1, an exemplary system 100 that facilitates automatically determining a vehicle class for a vehicle captured in an image output by a radar-based imaging system is illustrated. In an exemplary surveillance application, it may be desirable to generate images of the surface of the earth from an aircraft that is flying over a particular region, from a satellite orbiting the earth, etc. It may be further desirable to automatically determine that an image output by the radar-based imaging system includes a vehicle. It may be still further desirable to automatically determine a vehicle class of such vehicle, wherein exemplary vehicle classes include “tank”, “sedan”, “truck”, “sport utility vehicle”, etc. The system 100 is configured to perform the above-mentioned operations.

The system 100 includes radar-based imaging system 102 that, for example, may be included in an aircraft that is flying over a particular geographic region, may be included in a satellite orbiting the earth, etc. It is to be understood that location of the radar-based imaging system 102 relative to the surface of the earth is arbitrary. For example, the radar-based imaging system 102 can be positioned on an airplane, a helicopter, an unmanned aerial vehicle (UAV), in a satellite, may be affixed to a mobile platform, etc. In an exemplary embodiment, the radar-based imaging system 102 may be particularly well suited for surveillance applications, as such a system 102 can output images of the surface of the earth 104 in inclement weather conditions (e.g., through cloud cover), during the night, etc. In an exemplary embodiment, the radar-based imaging system 102 may be a synthetic aperture radar (SAR) imaging system.

As indicated above, the radar-based imaging system 102 can be positioned at any suitable height over the surface of the earth 104 to capture images of the earth 104. In an exemplary embodiment, the radar-based imaging system 102, when outputting images, can be at least 20 feet above the surface of the earth 104 and may be as high as several thousand miles above the surface of the earth 104.

The system 100 further comprises a computing apparatus 106 that is in communication with the radar-based imaging system 102. The computing apparatus 106, in an example, may be co-located with the radar-based imaging system 102. In another exemplary embodiment, the computing apparatus 106 may be positioned at a base and can receive two-dimensional images from the radar-based imaging system 102 by way of a suitable wireless connection.

As will be described in greater detail herein, the computing apparatus 106 can be programmed to analyze images output by the radar-based imaging system 102. Analysis of an image can include detecting a vehicle in the image and determining a vehicle class of the vehicle in the image. Furthermore, analysis of the image can include assigning a label that is indicative of the vehicle class to the image and/or outputting an indication to an operator as to the vehicle class. While examples set forth herein are made with reference to a single image output by the radar-based imaging system 102 that includes a single vehicle, it is to be understood that, in operation, the computing apparatus 106 receives multiple images over time from the radar-based imaging system 102, and that an image generated by the radar-based imaging system 102 can include multiple vehicles.

In the example shown in FIG. 1, the radar-based imaging system 102 is directed towards the surface of the earth 104, wherein a vehicle 108 (which may be mobile or stationary) is in a field of view of the radar-based imaging system 102. Accordingly, the radar-based imaging system 102 outputs an image that includes the vehicle 108, wherein the image comprises a plurality of pixels that have a respective plurality of intensity values.

The radar-based imaging system 102 is in communication with the computing apparatus 106, and the computing apparatus 106 receives the image output by the radar-based imaging system 102. The computing apparatus 106 comprises a plurality of components that act in conjunction to determine a vehicle class of the vehicle 108 captured in the image.

To that end, the computing apparatus 106 can optionally include a normalizer component 110 that can perform at least one normalizing operation on the image output by the radar-based imaging system 102. Exemplary normalizing operations include, but are not limited to, scaling the image based upon bandwidth of a radar signal used by the radar-based imaging system 102 to generate the image, de-blurring the image based upon velocity of a vehicle (e.g., aircraft, satellite, . . . ) upon which the radar-based imaging system 102 resides, rotating the image based upon direction of travel of the vehicle upon which the radar-based imaging system 102 resides, filtering the image to reduce noise therein, interpolating values corresponding to “hot” or “dead” pixels, etc. The output of the normalizer component 110 can thus be a normalized image.

A cuer and indexer component 112 can be in communication with the normalizer component 110. As noted above, the normalizer component 110 is optionally included in the computing apparatus 106; thus, the cuer and indexer component 112 can receive the normalized image output by the normalizer component 110 or can receive the original image output by the radar-based imaging system 102. For purposes of explanation, actions of the cuer and indexer component 112 are described with respect to “the image”, which is intended to encompass both the normalized image and the original image.

Thus, the cuer and indexer component 112 receives the image and identifies a portion of the image that comprises the vehicle 108, wherein the cuer and indexer component 112 can utilize any suitable technique when identifying the portion of the image that comprises the vehicle 108. In an exemplary embodiment, the cuer and indexer component 112 can compute an intensity gradient image for the received image, and can identify the portion that comprises the vehicle by detecting edges in the intensity gradient image. The cuer and indexer component 112 can then output the portion of the image that comprises the vehicle 108.

In an exemplary embodiment, the cuer and indexer component 112 can output the portion of the image that comprises the vehicle 108 based upon a class of vehicle with respect to which the portion is desirably tested. Thus, size of the portion output by the cuer and indexer component 112 may depend upon a class of vehicle being searched for by the computing apparatus 106. For instance, if it is desirable to determine if the vehicle 108 is a tank, size of the portion of the image may be greater than if it is desirable to determine if the vehicle 108 is a sedan. Still further, size of the portion output by the cuer and indexer component 112 may depend upon a viewing angle being considered when determining the class of the vehicle 108, wherein the viewing angle can be a function of center frequency of a radar signal used to generate the image and aperture transversed to form the image Still further, while the cuer and indexer component 112 has been described as receiving a normalized image output by the normalizer component 110, it is to be understood that the normalizer component 110 may receive the portion of the original image output by the cuer and indexer component 112, and may perform at least one normalizing operation on the portion of the image.

The computing apparatus 106 further comprises a signature generator component 114 that is in communication with the cuer and indexer component 112. The signature generator component 114 receives the portion of the image output by the cuer and indexer component 112 and generates a signature for the portion of the image (e.g., generates a signature for the vehicle 108 included in the portion of the image). As will be described herein, the signature generated by the signature generator component 114 can be a one-dimensional array having a plurality of elements, each element having a respective value assigned thereto. When generating the signature, the signature generator component 114 can identify the major axis of the vehicle 108 (e.g., the longer side of the portion of the image output by the cuer and indexer component 112). Such major axis can have a plurality of points (e.g., pixels) along its length. The signature generator component 114, for each point along the length of the major axis, can sum intensity values of pixels in a row along the width of the portion of the image that intersect a respective point. As indicated above, the signature output by the signature generator component 114 can be based upon a particular vehicle class with respect to which the signature is desirably tested and a particular viewing angle.

The computing apparatus 106 also includes a data repository 116, wherein the data repository 116 comprises a plurality of template signatures 118-120. Each template signature in the plurality of signature templates 118-120 corresponds to a particular class and viewing angle. Therefore, the first template signature 118 can be a template signature for a first vehicle class and a first viewing angle, while the nth template signature 120 may also be a template signature for the first vehicle class and a second viewing angle. In another example, the nth template signature 120 may be a template signature for an nth vehicle class and a particular viewing angle.

The computing apparatus 106 also includes a comparer component 122 that is in communication with the signature generator component 114 and can access the data store 116. The comparer component 122 retrieves a template signature from the data store 116 for the vehicle class and the viewing angle for which the signature was generated. The comparer component 122 then compares the signature output by the signature generator component 114 with the retrieved template signature, and outputs a similarity score based upon the comparison. The similarity score is indicative of a similarity between the signature output by the signature generator component 114 and the retrieved template signature. The comparer component 122 can determine whether the vehicle 108 belongs to the class based upon such similarity score. For instance, if the similarity score is above a threshold, the comparer component 122 can determine that the vehicle 108 belongs to the class corresponding to the template signature retrieved from the data store 116.

The computing apparatus 106 further optionally includes a labeler component 124 that is in communication with the comparer component 122. The labeler component 124 can assign a label to the image based upon the similarity score; for instance, when the comparer component 122 determines a vehicle class for the vehicle, the labeler component 124 can label the image indicating as much. Moreover, the labeler component 124 can cause an indication to be output to an analyst that informs the analyst that a vehicle of the particular vehicle class has been identified.

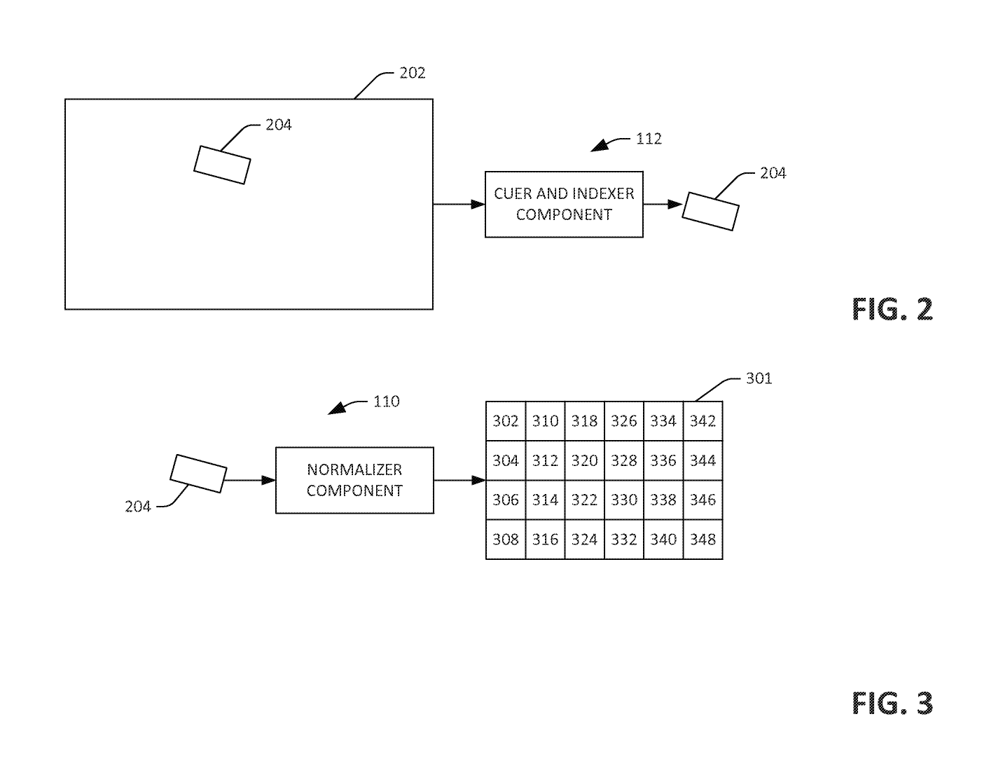

Referring now to FIG. 2, exemplary operation of the cuer and indexer component 112 is depicted. As indicated above, the radar-based imaging system 102 can generate an image 202 of the surface of the earth 104, wherein the image 202 includes a portion 204 that includes the vehicle 108. The cuer and indexer component 112 may then output the portion 204, wherein the portion includes a plurality of pixels having a respective plurality of intensity values. As noted above, size of the portion 204 may be a function of a class of vehicle with respect to which the portion 204 is desirably tested. In another example, the cuer and indexer component 112 can generate the portion 204 such that it is sufficiently large to encompass any class of vehicle for which the portion 204 is desirably tested.

Referring to FIG. 3, exemplary operation of the normalizer component 110 is depicted. For example, the normalizer component 110 can receive the portion 204 of the image 202, wherein such portion 204 may be associated with a particular scale (e.g., based bandwidth of the radar signal used to generate the image). Likewise, the portion 204 of the image 202 may be misaligned with respect to rows and columns of pixels in the image 202. Accordingly, for example, the normalizer component 110 can scale and rotate the portion 204 of the image 202 to generate a normalized portion 301. The normalized portion 301 comprises a plurality of pixels 302-348 that have a respective plurality of values. Additionally, the normalizer component 110 can perform a filtering operation over values in the pixels 302-348 (e.g., to remove outliers, to decreased noise, etc.). In FIGS. 2 and 3, the normalizing operations are described as being performed subsequent to the portion 204 of the image 202 being identified; as noted above, however, in another exemplary embodiment the normalizing operations can be performed on the image 202 prior to the portion 204 being identified.

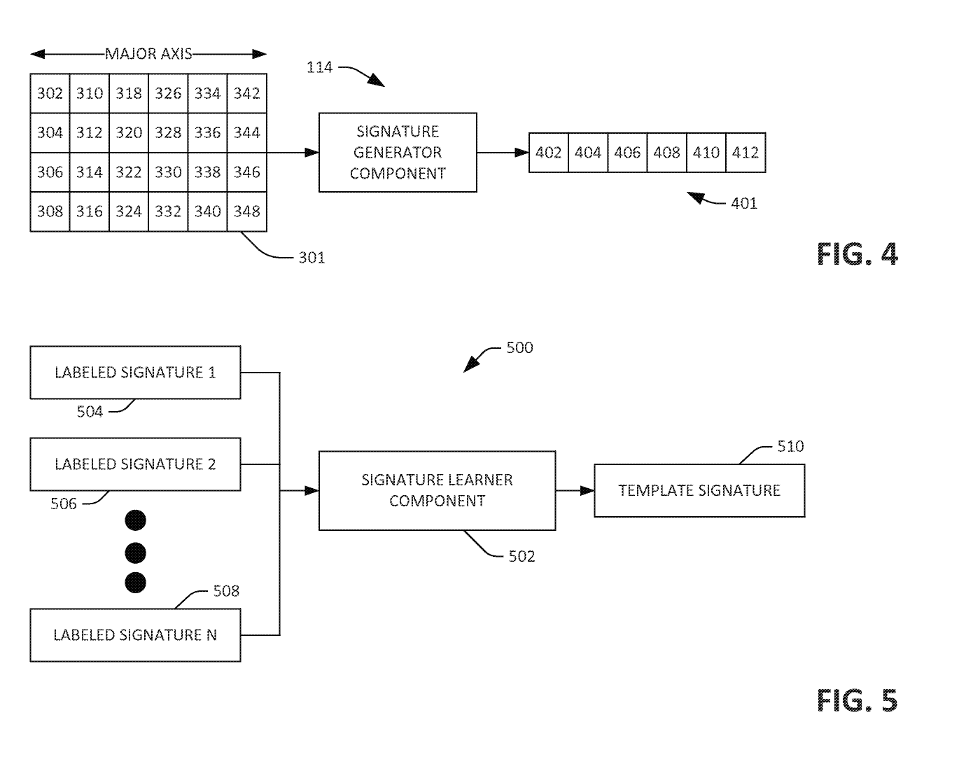

Now referring to FIG. 4, exemplary operation of the signature generator component 114 is illustrated. The signature generator component 114 receives the normalized portion 301 and generates a signature 401 for the portion 204 of the image 202 based upon intensity values of pixels in the normalized image 301. The signature 401 is a one-dimensional array having a plurality of elements 402-412 that have a respective plurality of values assigned thereto.

With more particularity, the signature generator component 114 can identify a major axis of the vehicle 108 in the normalized portion 301. As shown, the major axis can be along a lateral length of the normalized portion 301. The major axis has a plurality of points along its length, each point corresponding to a column of pixels along a width of the normalized portion 301. Accordingly, a first point along the major axis corresponds to the column of pixels 302-308, a second point along the major axis corresponds to the column of pixels 310-316, and so forth. A number of elements in the signature 401 corresponds to the number of columns in the normalized portion 301 (e.g., a number of columns along the width of the normalized portion 301). Further, each element in the signature 401 has a value that is based upon a summation of pixels in the column corresponding to such element. Therefore, for example, the element 402 in the signature 401 has a value that is based upon a summation of intensity values of the respective pixels 302-308 in the normalized portion 301. Similarly, the element 404 in the signature 401 has a value that is based upon a summation of intensity values of the respective pixels 310-316 in the normalized portion.

The comparer component 122 may then compare the signature 401 with a template of a vehicle class and viewing angle with respect to which the signature generator component 114 generated the signature 401. The length and/or width of the normalized portion 301 may change when the portion 204 of the image 202 is desirably tested with respect to a different class and/or different viewing angle. The signature generator component 114, however, utilizes a similar process to generate signatures.

Now referring to FIG. 5, an exemplary system 500 that facilitates learning a template signature for a particular viewing angle and vehicle class is illustrated. The system 500 includes a signature learner component 502 that receives a plurality of labeled signatures 504-508. Each signature in the plurality of labeled signatures 504-508 has been labeled as being representative of a vehicle of a particular type when captured in an image at a certain viewing angle or range of viewing angles. The signature learner component 502 may utilize any suitable learning technique to output a template signature 510 for the vehicle class and viewing angle(s). In an exemplary embodiment, the template signature 510 can be or include a data structure that comprises data that indicates variances in length of the labeled signatures 504-508 (e.g., the first labeled signature 504 may have a different number of elements when compared to the second labeled signature 506). The template signature 510 can further be or include a data structure that comprises data that indicates variances in values of elements in the labeled signatures 504-508. As the template signature 510 can represent observed variances in labeled signatures, the template signature 510 can be employed by the comparer component 122 to relatively robustly classify vehicles as belonging to the vehicle class.

While the approach described herein has been described as a one-to-one comparison between a signature output by the signature generator component 114 and a template signature for a vehicle class and viewing angle, it is to be understood that other approaches are contemplated. For example, a neural network can be built based upon labeled signatures that correspond to vehicles of particular classes. The neural network can include an output layer that has a plurality of nodes that are respectively representative of vehicle classes. In operation, the neural network can receive a signature from the signature generator component 114 as input, and can output a probability distribution over the vehicle classes based upon such signature. Such neural network can be learned by way of any suitable approach, such as back propagation. Other approaches are also contemplated.

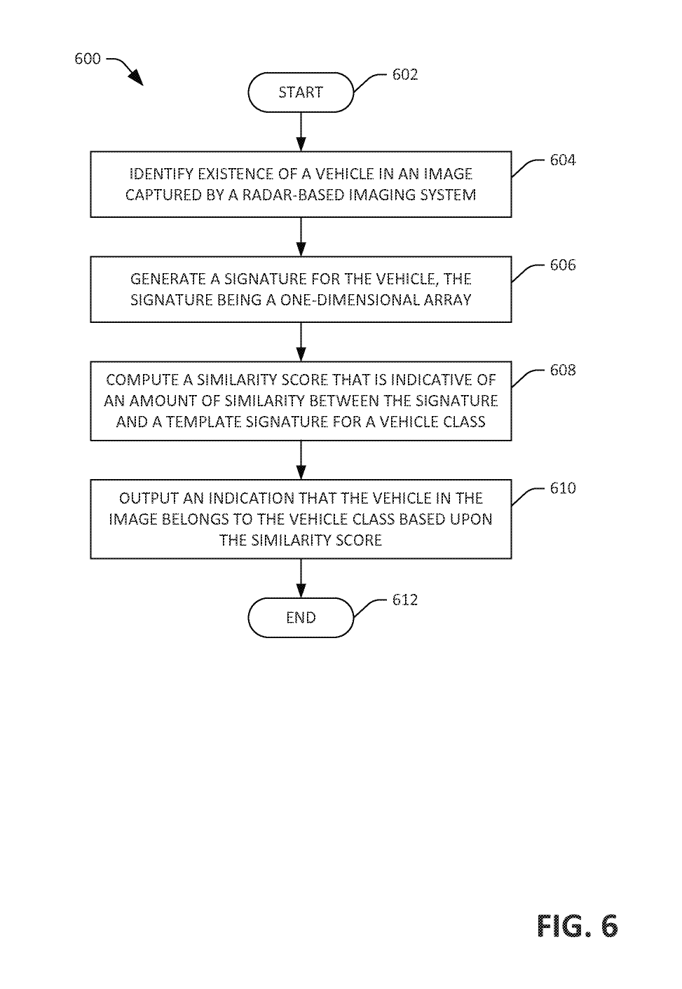

FIGS. 6-8 illustrate exemplary methodologies relating to determining a vehicle class for a vehicle captured in an image. While the methodologies are shown and described as being a series of acts that are performed in a sequence, it is to be understood and appreciated that the methodologies are not limited by the order of the sequence. For example, some acts can occur in a different order than what is described herein. In addition, an act can occur concurrently with another act. Further, in some instances, not all acts may be required to implement a methodology described herein.

Moreover, the acts described herein may be computer-executable instructions that can be implemented by one or more processors and/or stored on a computer-readable medium or media. The computer-executable instructions can include a routine, a sub-routine, programs, a thread of execution, and/or the like. Still further, results of acts of the methodologies can be stored in a computer-readable medium, displayed on a display device, and/or the like.

With reference now to FIG. 6, an exemplary methodology 600 that facilitates outputting an indication that an image includes a vehicle of a particular class is illustrated. The methodology 600 starts at 602, and at 604, existence of a vehicle in an image captured by a radar-based imaging system is detected. At 606, a signature is generated for the vehicle. As indicated above, such signature can be based upon a particular vehicle class and/or viewing angle with respect to which the vehicle existent in the image is desirably tested. At 608, a similarity score that is indicative of an amount of similarity between the signature and a template signature for the vehicle class and/or viewing angle is computed. At 610, an indication is output that the vehicle in the image belongs to the vehicle class based upon the similarity score. In other words, if the generated signature is found to closely correspond to the template signature, then an indication can be output that the vehicle belongs to the vehicle class represented by the template signature. The methodology 600 completes at 612.

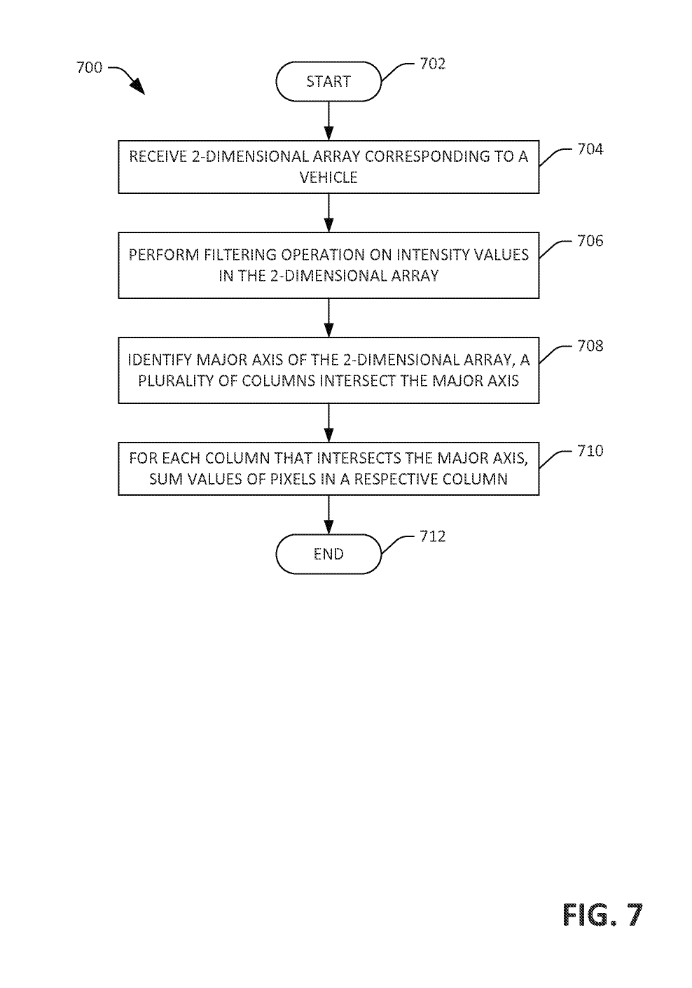

With reference to FIG. 7, an exemplary methodology 700 that facilitates constructing a signature for a vehicle detected in an image is illustrated. The methodology 700 starts at 702, and at 704, a two-dimensional array corresponding to a vehicle in an image is received. Such two-dimensional array can be an array of pixel intensity values identified as potentially corresponding to the vehicle. At 706, a filtering operation is performed on intensity values in the two-dimensional array of pixels. Such filtering operation can be employed to remove outliers, noise, etc.

At 708, a major axis of the two-dimensional array is identified, wherein a plurality of columns of pixels intersect the major axis. Width of the two-dimensional array can be based upon a vehicle class and/or viewing angle with respect to which the two-dimensional array is desirably tested. At 710, for each column of pixels that intersects the major axis, values of such pixels are summed. An element of a resultant signature is based upon the sums of values of a column. The methodology 700 completes at 712.

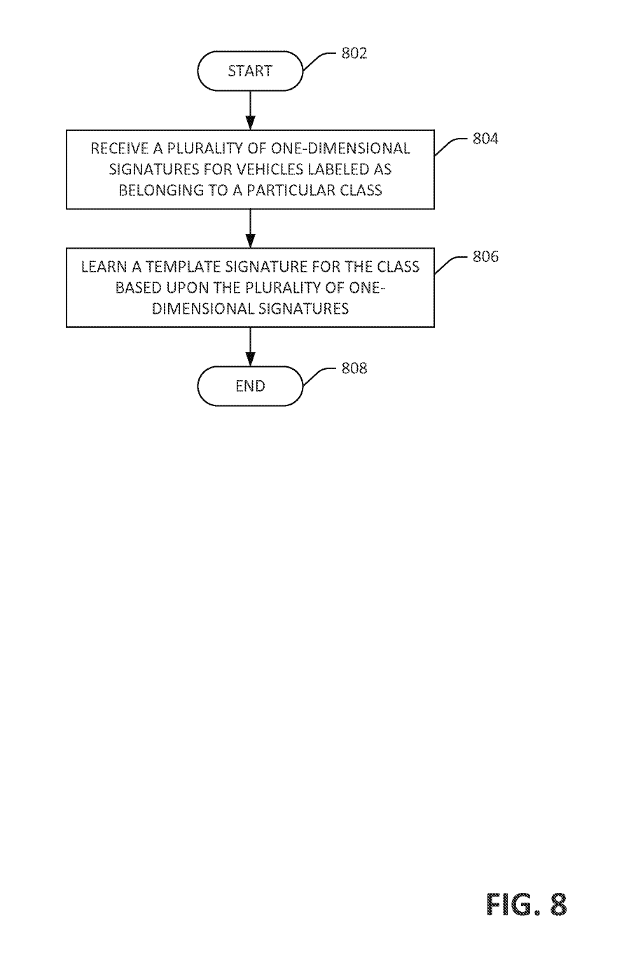

Turning to FIG. 8, an exemplary methodology 800 that facilitates learning a template signature for a particular vehicle class and viewing angle is illustrated. The methodology 800 starts at 802, and at 804, a plurality of one-dimensional signatures for vehicles are received, wherein such signatures are labeled as belonging to a particular vehicle class and/or viewing angle. At 804, a template signature for the vehicle class and/or viewing angle is learned based upon the plurality of one-dimensional signatures. The methodology 800 completes at 806.

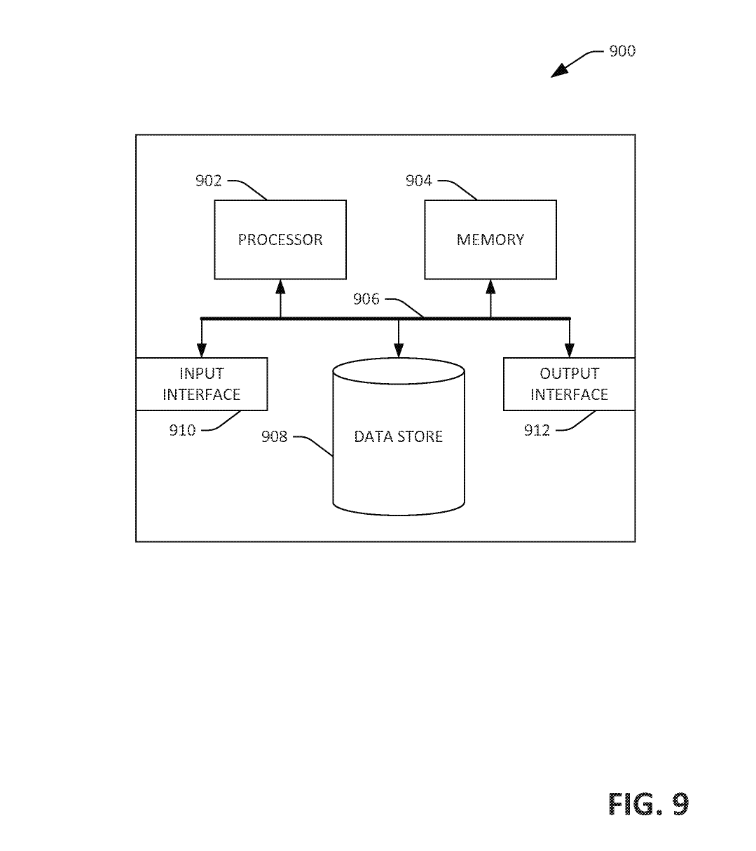

Referring now to FIG. 9, a high-level illustration of an exemplary computing device 900 that can be used in accordance with the systems and methodologies disclosed herein is illustrated. For instance, the computing device 900 may be used in a system that is used to determine a class of a vehicle detected in an image generated by way of a radar-based imaging system. By way of another example, the computing device 900 can be used in a system that learns template signatures for a vehicle class. The computing device 900 includes at least one processor 902 that executes instructions that are stored in a memory 904. The instructions may be, for instance, instructions for implementing functionality described as being carried out by one or more components discussed above or instructions for implementing one or more of the methods described above. The processor 902 may access the memory 904 by way of a system bus 906. In addition to storing executable instructions, the memory 904 may also store images, template signatures, etc.

The computing device 900 additionally includes a data store 908 that is accessible by the processor 902 by way of the system bus 906. The data store 908 may include executable instructions, images, template signatures, etc. The computing device 900 also includes an input interface 910 that allows external devices to communicate with the computing device 900. For instance, the input interface 910 may be used to receive instructions from an external computer device, from a user, etc. The computing device 900 also includes an output interface 912 that interfaces the computing device 900 with one or more external devices. For example, the computing device 900 may display text, images, etc. by way of the output interface 912.

Additionally, while illustrated as a single system, it is to be understood that the computing device 900 may be a distributed system. Thus, for instance, several devices may be in communication by way of a network connection and may collectively perform tasks described as being performed by the computing device 900.

Various functions described herein can be implemented in hardware, software, or any combination thereof. If implemented in software, the functions can be stored on or transmitted over as one or more instructions or code on a computer-readable medium. Computer-readable media includes computer-readable storage media. A computer-readable storage media can be any available storage media that can be accessed by a computer. By way of example, and not limitation, such computer-readable storage media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray disc (BD), where disks usually reproduce data magnetically and discs usually reproduce data optically with lasers. Further, a propagated signal is not included within the scope of computer-readable storage media. Computer-readable media also includes communication media including any medium that facilitates transfer of a computer program from one place to another. A connection, for instance, can be a communication medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio and microwave are included in the definition of communication medium. Combinations of the above should also be included within the scope of computer-readable media.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

What has been described above includes examples of one or more embodiments. It is, of course, not possible to describe every conceivable modification and alteration of the above devices or methodologies for purposes of describing the aforementioned aspects, but one of ordinary skill in the art can recognize that many further modifications and permutations of various aspects are possible. Accordingly, the described aspects are intended to embrace all such alterations, modifications, and variations that fall within the spirit and scope of the appended claims. Furthermore, to the extent that the term “includes” is used in either the details description or the claims, such term is intended to be inclusive in a manner similar to the term “comprising” as “comprising” is interpreted when employed as a transitional word in a claim.

What is claimed is:

1. A method comprising:
detecting existence of a vehicle in an image of a region captured by a radar-based imaging system, the vehicle located in a portion of the image, the portion of the image comprising a plurality of pixels that have a respective plurality of pixel values;
responsive to detecting the existence of the vehicle, generating a signature for the vehicle based upon the plurality of pixel values, the signature being a one dimensional array that comprises a plurality of elements, the plurality of elements having a respective plurality of element values assigned thereto;
computing a similarity score that is indicative of an amount of similarity between the signature and a template signature for a vehicle class; and
outputting an indication that the vehicle in the image belongs to the vehicle class based upon the similarity score.

2. The method of claim 1, wherein the radar-based imaging system is a synthetic aperture radar (SAR) imaging system.

3. The method of claim 1, wherein the radar-based imaging system is included in an airplane or an orbiting satellite.

4. The method of claim 1, wherein the radar-based imaging system is affixed to a mobile platform.

5. The method of claim 1, where identifying the existence of the vehicle in the image comprises:
computing an intensity gradient image based upon intensity values assigned to respective pixels in the image; and
identifying the existence of the vehicle based upon the intensity gradient image.

6. The method of claim 1, wherein generating the signature for the vehicle comprises:
identifying a major axis of the vehicle in the image, the major axis extending along a length of the vehicle, the signature generated based upon the identifying of the major axis of the vehicle.

7. The method of claim 6, wherein generating the signature for the vehicle further comprises:
summing intensity values in respective columns of pixels that are orthogonal to the major axis of the vehicle, the signature based upon the summing of the intensity values of the pixels.

8. The method of claim 7, the vehicle class being one of a truck class, a passenger sedan class, a sport-utility vehicle class, a van class, a heavy armor class, an air defense class, or a personnel transport class.

9. The method of claim 1, further comprising generating a plurality of signatures for the vehicle, each signature corresponding to a respective potential viewing angle.

10. The method of claim 1 continuously executed as the radar-based imaging system outputs additional images.

11. A computing apparatus comprising:
a processor; and
a memory that comprises a plurality of components that are executed by the processor, the plurality of components comprising:
a signature generator component that generates a signature for a portion of an image output by a radar-based imaging system, the signature being a one dimensional array that comprises a plurality of elements having a respective plurality of values, the portion of the image labeled as comprising a vehicle;
a comparer component that compares the signature with a template signature for a vehicle class, the comparer component outputting a similarity score that is based upon an amount of similarity between the signature and the template signature; and
a labeler component that assigns a label to the image that indicates that the vehicle belongs to the vehicle class based upon the similarity score.

12. The computing apparatus of claim 11, the radar-based imaging system is a synthetic aperture radar (SAR) imaging system.

13. The computing apparatus of claim 11, wherein the signature generator component identifies a major axis of the vehicle and generates the signature based upon the major axis of the vehicle, each element in the one-dimensional array corresponding to a respective point along the major axis of the vehicle.

14. The computing apparatus of claim 13, wherein the signature generator component receives data that is indicative of a width of the vehicle orthogonal to the major axis, each element in the one-dimensional array corresponding to a respective summation of intensity values of pixels orthogonal to the respective point over the width of the vehicle.

15. The computing apparatus of claim 11, wherein the signature generator component generates a plurality of signatures for the portion of the image, each signature corresponding to a respective potential viewpoint of the vehicle as captured in the image.

16. The computing apparatus of claim 11, wherein the signature generator component generates a plurality of signatures for respective portions of the image, sizes of the respective portions of the image based upon vehicle classes against which the respective portions of the image are desirably tested.

17. The computing apparatus of claim 11, the plurality of components further comprising a cuer and indexer component that receives the image from the radar-based imaging system and identifies the portion of the image as comprising the vehicle.

18. The computing apparatus of claim 11, further comprising a normalizer component that performs at least one normalizing operation on the image, the portion of the image based upon the normalizing operation performed on the image by the normalizer component.

19. The computing apparatus of claim 18, the normalizer component performs the normalizing operation based upon at least one of a bandwidth of a radar signal used by the radar-based imaging system to generate the image, center frequency of the radar signal used by the radar-based imaging system to generate the image, or an aperture transversed by the radar-based imaging system to generate the image.

20. A computer-readable storage medium comprising instructions that, when executed by a processor, cause the processor to perform acts comprising:
receiving an image from a synthetic aperture radar imaging system;
identifying a portion of the image that includes a vehicle, the portion of the image comprising a plurality of pixels having a respective plurality of values;
generating a signature for the vehicle, wherein generating the signature comprises:
identifying a major axis of the vehicle, the major axis comprising a plurality of points along a length of the vehicle;
for each point in the plurality of points, summing intensity values of pixels along a minor axis of the vehicle over a predefined width of the vehicle, wherein the signature is a one-dimensional array having a plurality of elements, each element corresponding to a respective point along the major axis of the vehicle and having a respective value that is based upon the summing of the intensity values of the pixels along the minor axis;
comparing the signature with a template signature for a vehicle class;
generating a similarity score that is indicative of a similarity between the signature and the template signature; and
labeling the image as including the vehicle of the vehicle class based upon the similarity score.
